(19) United States
(12) Patent Application Publication
(10) Pub. No.: US 2025/0028900 A1
(43) Pub. Date: Jan. 23, 2025

(54) METHOD FOR DATA ANALYSIS BY LARGE LANGUAGE MODEL, AND GRAPHIC USER INTERFACE SYSTEM THEREOF

(71) Applicant: INDICO DATA SOLUTIONS Inc., Boston, MA (US)

(72) Inventors: Benjamin TOWNSEND, Plymouth (GB); Madison MAY, Asheville, NC (US); Christopher WELLS, Kennett Square, PA (US)

(73) Assignee: INDICO DATA SOLUTIONS Inc., Boston, MA (US)

(21) Appl. No.: 18/770,412

(22) Filed: Jul. 11, 2024

Related U.S. Application Data
(60) Provisional application No. 63/514,448, filed on Jul. 19, 2023.

(51) Int. Cl. G06F 40/20

(52) U.S. Cl. CPC G06F 40/20

(57) ABSTRACT

A method and Graphic User Interface (GUI) system of data analysis for training a discriminative machine learning model are provided. One or more sets of data are provided to a large language model (LLM) for a predefined task with or without prompts provided by a user; the results output by the LLM is compared with a set of initial human-supplied ground truth data generated by the user to produce performance metrics, the user may provide or update one or more prompts for the LLM based on the performance metrics till the performance metrics reach a threshold. The set of initial human-supplied ground truth data and the results of the LLM can be used to train a discriminative machine learning model.

### CROSS-REFERENCE TO RELATED APPLICATION

The present disclosure claims benefit of and priority to the U.S. Provisional Patent Application No. 63/514,448 filed on Jul. 19, 2023, the disclosure of which is incorporated herein by reference in its entirety.

### TECHNICAL FIELD

This disclosure relates to a method for data analysis using Large Language Model (LLM), and a Graphic User Interface (GUI) system thereof allowing a user to refine a set of training data, and efficiently analyze, extract or label data that can be used for training a language processing model, for example a natural language processing model, specifically a discriminative machine learning model like a small, for-purpose, fine-tuned transformer.

### BACKGROUND

In the field of machine learning, data annotation plays a vital role in training models and improving their accuracy. It involves the process of labeling or tagging data points with relevant information or attributes. However, data annotation can be a challenging and time-consuming task.

### SUMMARY

The present disclosure discloses a method for data analysis combining human expertise with the capabilities of a Large Language model (LLM), such as Generative Pre-trained Transformers (GPT). This method enables the bootstrapping and subsequent refinement of human data annotation, leading to improved accuracy, scalability, efficiency, and reduced time to a production quality model.

Discriminative machine learning models, also known as supervised models, focus on learning the boundary or decision boundary between different classes or categories. They learn the relationship between the input features and the corresponding output labels. These models are trained on labeled data, where each data point is annotated with the correct class or label. Discriminative models make predictions based on the learned patterns and can be effective in tasks such as classification, regression, or object detection.

On the other hand, generative machine learning models aim to understand the underlying probability distribution of the data. They learn the joint distribution of the input features and output labels. Generative models can generate new data samples that resemble the training data distribution. These models are often used for tasks like data synthesis, data augmentation, or anomaly detection. Common generative models include Generative Pre-trained Transformer (for example GPT-4), Gaussian Mixture Models (GMM), Hidden Markov Models (HMM), Variational Autoencoders (VAE), and Generative Adversarial Networks (GANs).

Both discriminative and generative models have their own strengths and weaknesses, and their choice depends on the specific requirements of the task. Discriminative models excel in tasks where accurate classification or prediction is crucial, while generative models are more suitable when understanding the underlying data distribution or generating new data is essential.

One aspect of the application discloses a method of data analysis for training a discriminative machine learning model, comprising: providing a set of data; instructing a large language model (LLM) to review the set of data for a predefined task with or without one or more prompts by a user; producing performance metrics comparing results provided by the LLM to a set of initial human-supplied ground truth data generated by the user; providing or updating one or more prompts for the LLM by the user based on the performance metrics in a case that the performance metrics does not reach a threshold; generating one or more renewed results by the LLM according to the provided or updated one or more prompts and producing performance metrics of the one or more renewed results such that the performance metrics reach a threshold; and reviewing and submitting the set of initial human-supplied ground truth data and the renewed one or more results of the LLM for training the discriminative machine learning model.

In one aspect of the application, the method of data analysis for training a discriminative machine learning model further includes analyzing a set of predetermined amount of data by a user to generate the set of initial human-supplied ground truth data.

In one aspect of the application, the set of data to be reviewed comprises one or more documents comprising raw text.

In one aspect of the application, the method further comprises applying the one or more prompts to a set of data that the LLM has not seen.

In one additional of the application, the predetermined task comprising labeling, instant scaling, collection, classification or annotation.

In one additional aspect of the application, the discriminative machine learning model comprises a small, for-purpose, fine-tuned transformer.

In one additional aspect of the application, the discriminative machine learning model comprises a Robustly Optimized BERT Pretraining Approach (ROBERTa) model, a Decoding-enhanced BERT with disentangled attention (DeBERTa) model, or Longformer.

In one additional aspect of the application, the LLM comprises Generative Pre-trained Transformer (GPT).

In one additional aspect of the application, the performance metrics comprise F1-score, Precision, Recall, False+, False− or True+.

In one additional aspect of the application, the discriminative machine learning model comprises enabling human quality assurance of the results generated by the LLM before submitting, and the human quality assurance comprises checking or correcting the results by the user.

In one additional aspect of the application, the method further comprises providing one or more requirements to the LLM by the user for the data to meet or adhere to.

In one additional aspect of the application, the one or more requirements are provided to the LLM prior to or subsequent to the user providing or updating the one or more prompts to the LLM.

In one additional aspect of the application, the one or more requirements comprising predefined criteria or format for the data to meet or adhere to.

In one additional aspect of the application, the one or more requirements are provided to the LLM subsequent to the user providing or updating the one or more prompts to the LLM.

In one additional aspect of the application, the method further comprises generating one or more results by the LLM according to the provided one or more requirements, and producing performance metrics of the one or more results.

In yet another aspect of the application, a Graphic User Interface (GUI) system of data analysis for training a discriminative machine learning model is provided, comprising: an input arranged for providing a set of data to be analyzed by a Large Language Model (LLM); an interface for defining one or more fields by a user for the LLM to review the set of data for information; a display arranged for displaying one or more results output by the LLM in accordance with the defined one or more fields; a processor configured to produce performance metrics comparing the one or more results provided by the LLM to a set of initial human-supplied ground truth data, wherein the display is configured to display the performance metrics; an input for providing or updating one or more prompts for the LLM based on the performance metrics till the performance metrics reach a threshold; wherein the display is further configured to display one or more renewed results by the LLM according to the provided or updated one or more prompts and the performance metrics of the one or more renewed results; and a second interface for reviewing and submitting the set of initial human-supplied ground truth data and the renewed one or more results of the LLM for training the discriminative machine learning model.

The method comprises analyzing a set of predetermined amount of data by a user to generate a set of initial human-supplied ground truth data. The human-supplied ground truth data carry valuable domain-specific knowledge that can guide subsequent annotation efforts. The method further comprises training a discriminative model, for example, a smaller, for-purpose, fine-tuned transformer (e.g. including but is not limited to Robustly Optimized BERT Pre-training Approach-ROBERTa, a Robustly Optimized BERT Pretraining Approach (ROBERTa) model, Decoding-enhanced BERT with disentangled attention (DeBERTa), or Longformer) model using the initial human-supplied ground truth data and the labels generated through optimized prompting of a large language model (LLM) like GPT4.

In a further enhancement of the method for data analysis as disclosed in the present disclosure, an additional step is introduced to augment the refinement process of data annotation and model training. This enhancement involves the integration of a set of “requirements” that a user can specify, aimed at further improving the precision and accuracy of the Large Language Model's (LLM) data processing and annotation capabilities.

Specifically, the user is enabled to specify a set of ‘requirements’ that detailed criteria or formats that the data should meet or adhere to. For example, in tasks where the extraction or recognition of dates is required, the user can specify a requirement such as: must be in the format YYYY/MM/DD. These requirements are designed to refine the interpretation and annotation process by providing explicit criteria for the LLM to follow, thereby enhancing the precision of the outcomes.

The specified “requirements” can be supplied to the LLM prior to or subsequent to the original prompts, if provided, and the predictions that are returned, preferably, the “requirements” can be supplied to the LLM subsequent to the original prompts. This integration allows the LLM to utilize the additional context provided by the “requirements” to more accurately align its predictions or annotations with the user's expectations. By doing so, the LLM's capability to adhere to specific data formats or criteria is significantly enhanced, resulting in a more refined and precise set of extracted information.

The inclusion of “requirements” serves as a means to further optimize the prompt chain used in training discriminative machine learning models. By ensuring that the LLM's output more closely adheres to predefined formats and criteria, the overall precision of the prompt chain is improved. This, in turn, contributes to the efficacy of the discriminative model training process, especially in scenarios where adherence to specific data formats is critical for the accuracy and reliability of the model.

This enhancement builds upon the existing method by offering an additional layer of refinement for the data annotation process, leveraging human expertise to guide the LLM towards more precise and accurate data processing outcomes. The incorporation of “requirements” not only facilitates a more controlled and specific data analysis approach but also enriches the dataset with domain-specific precision, thereby augmenting the effectiveness of the subsequent discriminative machine learning model training.

A user is able to optimize one or more prompts provided to the LLM by relying on a set of performance metrics. Common performance metrics for document labeling tasks include F1-score, Precision, Recall, False+, False− or True+. These metrics measure how well the model is able to classify documents into the correct categories or extract key data elements from the raw text. F1 score, for example, gauges the model's performance based on the balance between precision and recall. In a traditional machine learning context this is useful:
1) guiding data annotators toward rare labels and mis-labeled data; and
2) guiding machine learning engineers to model settings that will improve accuracy.

A new set of data, for example, a new set of documents, which has not been seen by the LLM can be provided for the LLM to review. In this context, the F1 score is an indication of how successful the LLM will be in annotating new documents based on the user supplied and improved prompts.

The dataset is thus augmented by merging the initial human-supplied ground truth data with the dataset enriched with GPT-generated pseudo-labels which can be further reviewed by a user for any necessary correction. This combined dataset is thus configured to encompass a larger volume of annotated data, blending the expertise of human annotators with the model's zero-shot pattern recognition capabilities, wherein “zero-shot” refers to the model's ability to perform a task without any specific training on that task.

Traditional machine learning models often require explicit training on a specific task using labeled data. However, LLMs like GPT are pre-trained on vast amounts of diverse text data, allowing them to learn general language patterns and semantics. A LLM model can generate responses or make predictions for tasks it hasn't been explicitly trained on. For example, given a prompt or a set of instructions, the LLM can generate relevant text that aligns with the given input, even if it hasn't been fine-tuned or explicitly trained on that specific task.

This zero-shot behavior arises from the general language understanding and generation capabilities learned during pre-training. By leveraging the learned knowledge and patterns, LLMs can generate responses or predictions that demonstrate some level of understanding and coherence for unseen tasks or prompts.

Though LLMs can exhibit impressive zero-shot capabilities, their performance may not match that of models specifically trained on a particular task. Fine-tuning or training on task-specific data can thus lead to better performance and domain expertise.

The initial human-supplied ground truth data refers to the dataset that is manually labeled by human annotators. These annotators have expertise in understanding and annotating the specific patterns or features of the data. This ground truth data serves as a reliable reference for training and evaluating machine learning models.

A user, normally a reviewer having domain expertise, such as a system target user, plays a critical role in the refinement stage. The user would carefully review and validate the annotations, refining or adjusting the pseudo-labels or prompt based on his or her expertise.

On the other hand, the dataset enriched with GPT-generated pseudo-labels is obtained by leveraging the capabilities of the GPT model. In this case, the model is used to generate pseudo-labels, which are labels assigned to the data samples by the model itself without human intervention. The model's zero-shot pattern recognition capabilities enable it to recognize patterns or features in the data without specific training on that particular task.

A user's main responsibility is to review and validate the annotations that have been generated. They carefully examine the dataset, considering their domain expertise, and assess the quality and accuracy of the annotations. The user's expertise is valuable in refining the dataset because they can provide insights and corrections based on their deep understanding of the subject matter. They can identify any potential errors or inconsistencies in the annotations and make adjustments accordingly. This includes refining or adjusting the pseudo-labels, which are labels generated by the GPT model, or modifying the prompts used to generate those labels.

By involving a user with domain expertise in the refinement stage, the dataset can benefit from their knowledge and ensure that the annotations are aligned with the specific requirements and nuances of the task at hand. Their review and validation help improve the overall quality and reliability of the dataset, making it more suitable for training and evaluating machine learning models.

The blending of human-supplied ground truth data with GPT-generated pseudo-labels helps to create a more comprehensive and robust dataset. This augmented dataset can be used for various machine learning tasks, such as training and evaluating models for pattern recognition, classification, or other tasks where labeled data is required. By merging these two types of data, the combined dataset becomes larger and more diverse in terms of annotated examples. It benefits from the expertise of human annotators who provided the ground truth data, ensuring high-quality annotations. At the same time, it leverages the GPT model's ability to recognize patterns in the data and generate pseudo-labels, effectively expanding the coverage of annotations to a larger volume of data.

It is noted that the process of bootstrapping and refining the annotation should not end with a single iteration. Iterations are performed successively, incorporating feedback, reviewer expertise, and continuous fine-tuning of prompts. Each iteration should be able to refine the prompt, improve the annotation quality, and enhance the model's understanding of the task all of which is guided by the user's expertise and the prompt performance metrics.

The iterative nature of the process acknowledges that dataset annotation is an ongoing and dynamic task. It recognizes that there is room for improvement and refinement at each iteration. During each iteration, several actions are taken to enhance the dataset. First, the prompts used to generate annotations are refined. This involves adjusting and optimizing the instructions given to the model, which can lead to improved quality and accuracy of the generated labels. Additionally, the annotation quality is continuously improved. This can involve refining or adjusting the annotations themselves based on feedback and insights from the user and reviewer expertise. The user's domain knowledge and expertise play a crucial role in identifying areas that need refinement and making the necessary adjustments. Furthermore, the iterations aim to enhance the model's understanding of the task. By continually refining the annotations and prompts, the model is exposed to more accurate and refined examples, which can contribute to its learning and performance.

Throughout the iterations, the user's expertise and prompt performance metrics guide the refinement process. The user's insights and feedback are incorporated into the annotation process, ensuring that the dataset aligns with the desired goals and requirements. Prompt performance metrics provide quantitative measurements to assess the effectiveness and quality of the prompts, enabling data curators to make data-driven decisions for further improvements. By conducting successive iterations and incorporating feedback, reviewer expertise, and prompt fine-tuning, the annotation process becomes an ongoing and collaborative effort to create a high-quality dataset that continually improves and aligns with the task at hand.

The integration of GPT into the annotation process would yield numerous benefits. By combining human expertise with the efficiency of the language model, the annotation process could become more scalable, less time-consuming, and cost-effective. Leveraging GPT to bootstrap and refine human data annotation will lead to enhanced accuracy, broader coverage, and increased efficiency in producing high-quality labeled datasets.

These and other features and advantages will become further apparent from the detailed description and accompanying figures that follow. In the figures and description, numerals indicate the various features, like numerals referring to like features throughout both the drawings and the description.

### BRIEF DESCRIPTIONS OF THE DRAWINGS

FIG. 1 illustrates a flow diagram for generating data to train a discriminative model according to one embodiment of the disclosure;

FIG. 2 illustrates another flow diagram for generating data to train a discriminative model according to another embodiment of the disclosure;

FIGS. 3A-3G show illustrative screens in a GUI system using a Large Language Model (LLM) to review data for training a discriminative model according to one embodiment of this disclosure.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the claimed invention.

In the field of machine learning, it normally involves reviewing a predetermined set of data by a human, for example, to label a set of documents as ground truth data for future model training purpose. The examples shown below describe the use of a LLM model, such as GPT-4, in combination with human review, to help with an initial reviewing process.

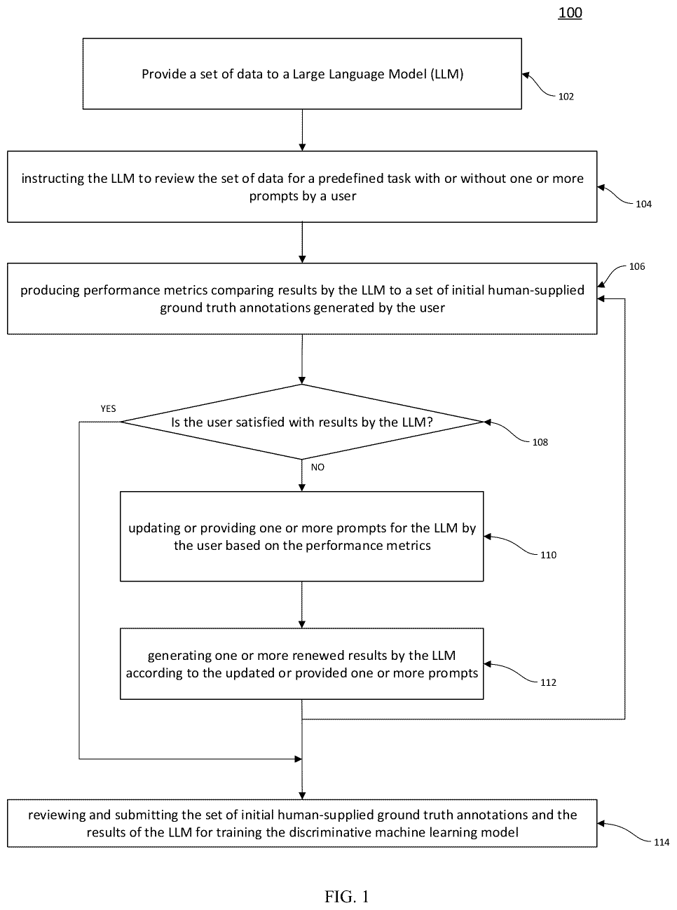

FIG. 1 illustrates a flow diagram (100) of data analysis for generating ground truth annotation data for training a discriminative model, showing one embodiment of the present disclosure.

In FIG. 1, a set of data, such as one or more unlabeled documents, can be provided by uploading them to a server or processor where a large language model (LLM) resides (102). A user may instruct the LLM model to perform one or more predefined tasks (104), for example, for a document labeling service. The labeling service may be conducted by the LLM model with or without any further instructions, i.e., prompts, from the user, other than an initial task or tasks set up by the user. The one or more unlabeled documents may have never been seen by the LLM model. This is normally being referred to as “Zero Shot” by a LLM.

A processor may produce performance metrics comparing results provided by the LLM to a set of initial human-supplied ground truth data generated by a user (106). The user normally has the expertise in the subject matter of the provided data, such as the one or more unlabeled documents. Common performance metrics for document labeling tasks include accuracy, precision, recall, and F1-score. F1 score, for example, gauges the model's performance based on the balance between precision and recall. These metrics measure how well the model is able to classify documents into the correct categories or extract key data elements from the raw text, the user can determine if he or she is satisfied with the results generated and provided by the LLM model based on the performance metrics (108). If the user is satisfied with the results, he or she can review and submit the set of initial human-supplied ground truth annotations and the results of the LLM for training a discriminative machine learning model (114). If the user is not satisfied with the results, the user having expertise in the one or more documents can further provide, adjust or fine tune instructions, i.e., prompts, to the LLM model in view of the performance metrics (110), the process of which is often referred to as a prompt-based learning. Prompt-based learning models can autonomously tune themselves for different tasks by transferring domain knowledge introduced through prompts. The LLM can generate one more renewed results according to the updated or provided one or more prompts (112) and the processor may produce performance metrics comparing the one or more renewed results to the set of initial human-supplied ground truth data generated by a user (106). The process can be repeated until the user is satisfied with the performance metrics. The user can eventually review and submit the set of initial human-supplied ground truth annotations and the results of the LLM for training the discriminative machine learning model (114).

This disclosure thus integrates a LLM model, such as GPT, into the annotation process, combining human expertise with the efficiency of the LLM model, guiding the LLM model towards a more restricted training process targeting the concerned set of data. The annotation process could thus become more scalable, less time-consuming, and cost-effective.

The set of initial human-supplied ground truth data and the results provided by the LLM can in combination be used as ground truth data to train a smaller, for-purpose, fine-tuned transformer, such as a Robustly Optimized BERT Pretraining Approach (ROBERTa) model.

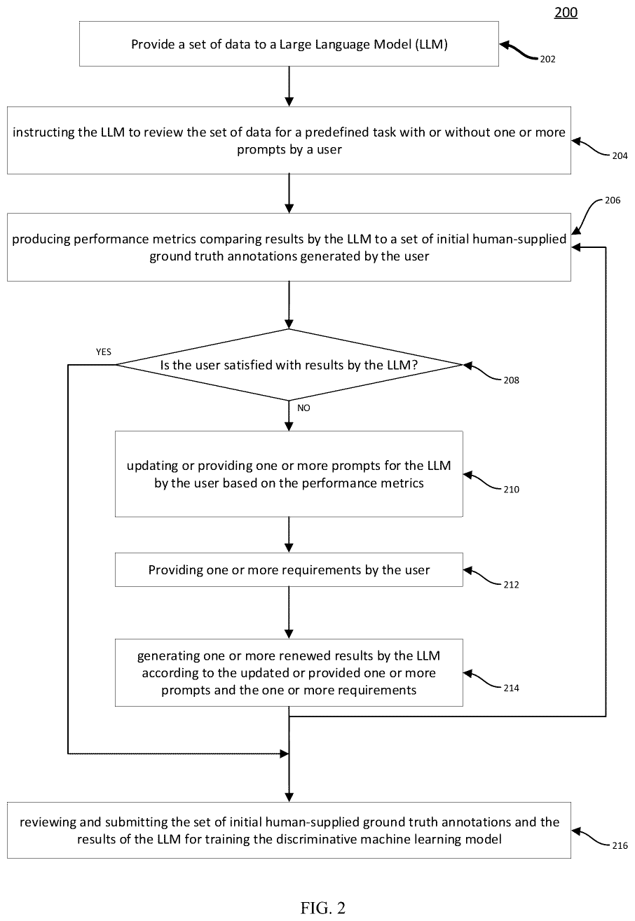

FIG. 2 illustrates another flow diagram (200) of data analysis for generating ground truth annotation data for training a discriminative model, showing another embodiment of the present disclosure.

In FIG. 2, a set of data, such as one or more unlabeled documents, can be uploaded to a server or processor where a large language model (LLM) is hosted or accessible (202). A user may direct the LLM to perform one or more predefined tasks (204), such as a document labeling service. Similar to the embodiment shown in FIG. 1, the labeling service can be executed by the LLM either with or without any additional user instructions or prompts, beyond the initial setup of tasks by the user. The documents being processed may be entirely new to the LLM. This scenario is typically referred to as “Zero Shot” learning by an LLM.

A processor may generate performance metrics by comparing results provided by the LLM to a set of initial ground truth data, which is created by a user (206). Based on these performance metrics, the user can evaluate whether the results generated by the LLM meet their expectations (208). If satisfied, the user can review and submit both the initial ground truth annotations and the LLM's results for training a discriminative machine learning model (216). If the results are not satisfactory, the user, who has expertise in the documents, may further refine, adjust, or fine-tune the instructions, i.e., prompts, given to the LLM based on the performance metrics (210). This process is often referred to as prompt-based learning, a method where learning models autonomously adjust to different tasks by incorporating domain knowledge via prompts. Additionally, the user may specify further requirements that the data must meet, such as adhering to specific formats or criteria (212).

Though in FIG. 2, the one or more requirements are shown to be provided to the LLM subsequent to the user providing or updating the one or more prompts to the LLM. It is worth noting that the one or more requirements can be provided prior to or subsequent to the user providing or updating the one or more prompts to the LLM. The LLM can generate one more renewed results according to the updated or provided one or more prompts and the one or more requirements (214), and the processor may produce performance metrics comparing the one or more renewed results to the set of initial human-supplied ground truth data generated by a user (206). The process can be repeated until the user is satisfied with the performance metrics. The user can eventually review and submit the set of initial human-supplied ground truth annotations and the results of the LLM for training the discriminative machine learning model (216).

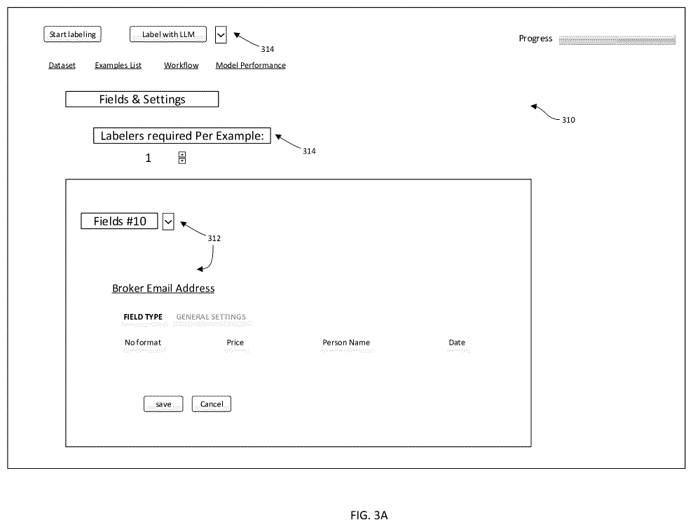

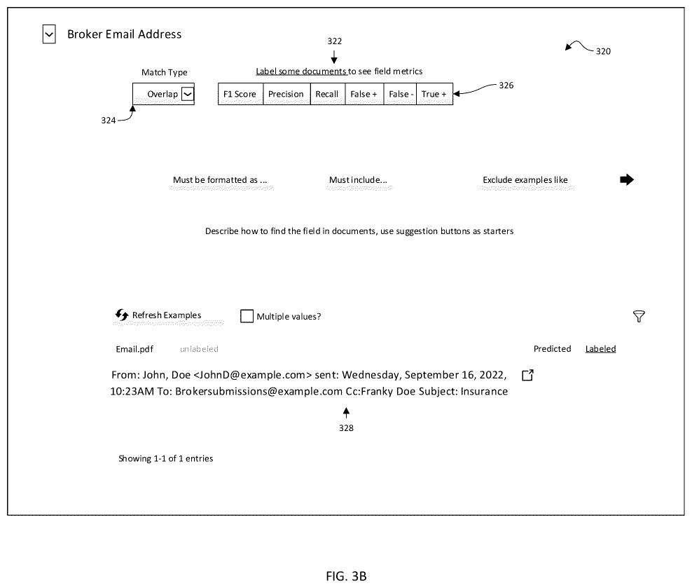

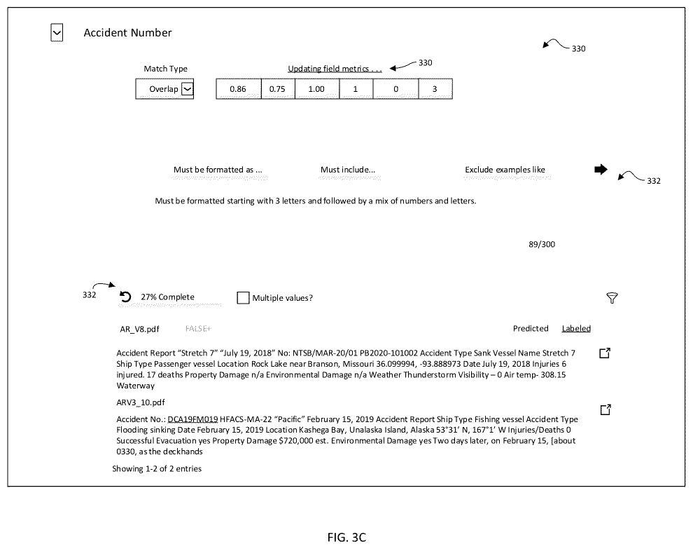

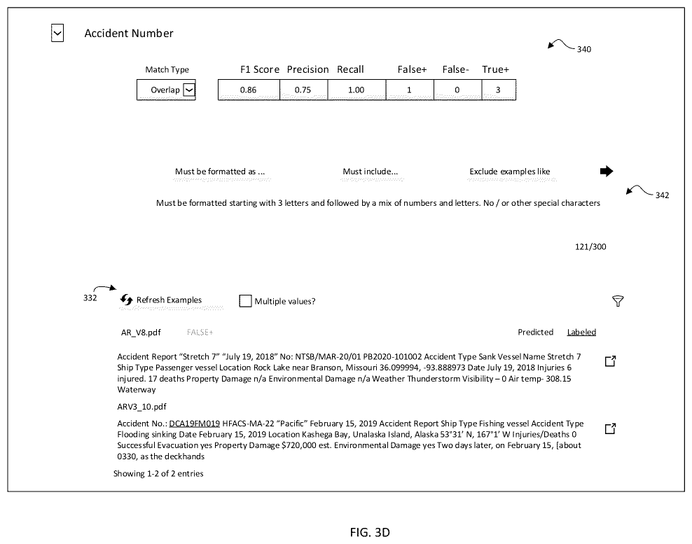

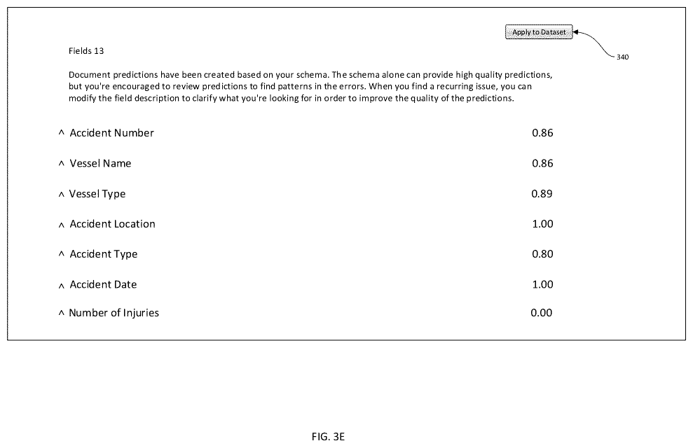

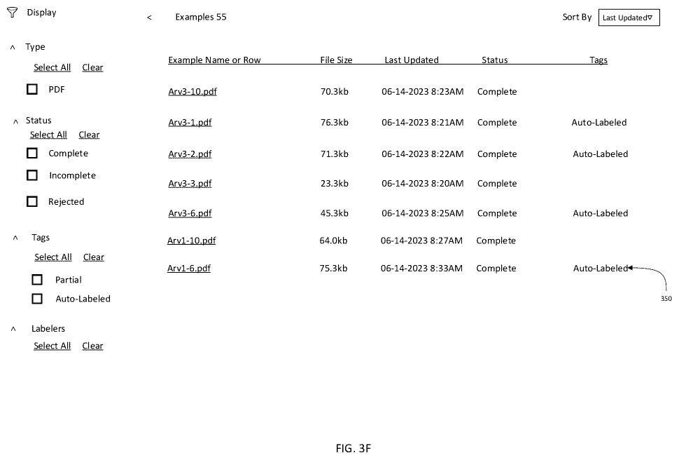

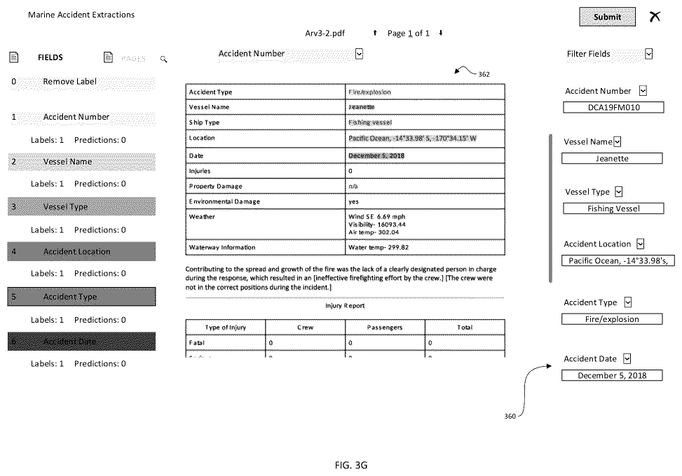

FIGS. 3A-3G illustrate user GUIs of data analysis for generating ground truth data for training a discriminative model according to an embodiment of this disclosure.

FIG. 3A provides an example of high level view (310) for setting one or more fields (312) of a task in a Graphic User Interface (“GUI”), a user is able to set up a task and define the one or more fields that the LLM model, such as GPT-4, is expected to extract from a set of data provided (the process of such provision and the specific set of data used are omitted herein), the set of data may include one or more documents being provided. The user may not have to specify the exact format of the information to be extracted. For example, in FIG. 3A, the user may define a field instructing the LLM model to extract the “Broker Email Address” from the provided one or more documents (omitted herein), without providing additional instructions (for example, without specific “prompts” or “requirements”). The user may select a specific LLM model (314) and click “Label with LLM” which will initiate the LLM such as GPT-4 to extract the broker email address from the provided document. It is noted that the user may be able to select (314) the types of LLM for the review. The user may also set the number of labelers required for each example (316).

FIG. 3B shows one or more results output by the LLM (320), identifying one or more documents with one or more email addresses predicted according to the field defined by the user in FIG. 3A. The user can further select the “Match Type” such as overlap, exact, partial etc. (324).

It is noted that a user can pre-label a subset of the data to provide a set of initial human-supplied ground truth data (322). The user normally has the expertise in the subject matter of the provided documents. The labeling process by the user is omitted herein.

As shown in FIG. 3B, the email address “JohnD@example.com” is predicted by the LLM which is contained in one document named “Email.pdf” (328). Performance metrics, for example field metrics in FIG. 3B, can be produced comparing results provided by the LLM to the set of initial human-supplied ground truth data generated by a user.

Common performance metrics (326) for document labeling tasks include F1-score, Precision, Recall, False+, False−, True+ etc, as show in FIG. 2B. These metrics measure how well the model is able to classify documents into the correct categories or extract key data elements from the raw text. F1 score, for example, gauges the model's performance based on the balance between precision and recall.

In another embodiment (330), as shown in FIG. 3C, for a set of provided document(s) (the process and specific documents are omitted herein), similar to what is shown in FIG. 3B, other than the field “Accident Number” that the user intends the LLM to extract from the set of one or more document(s), the user may also choose to provide minimal instructions (332), i.e., “prompts” or “requirements” for the data to adhere to, as to the desired information to be extracted, such as “must be formatted starting with 3 letters and followed by a mix of numbers and letters,” as shown herein in FIG. 3C. The user can choose to refresh the examples so that the LLM can generate and provide one or more renewed results based on the provided or updated prompts and/or requirements (332). The user having expertise in the one or more documents, if necessary, can further provide, adjust or fine tune instructions, i.e., prompts/requirements, to the LLM model (332). The results output by the LLM model for example show two entries when 27% of the reviewing is completed. Once completed, the field metrics or performance metrics will be updated for the one or more renewed results generated and provided by the LLM based on the provided or updated prompts/requirements (330). The reviewing process may be repeated by the LLM model based on the newly provided or fine-tuned prompts and/or requirements by the user, until the user is satisfied with the performance metrics. It is worth noting that the prompts may be general instructions, while the requirements referred to herein may be more specific and predefined formats or criteria that data should meet or adhere to, but according to different circumstances, these two may be the same or different from each other.

The field metrics is being updated while comparing results provided by the LLM to a set of initial human-supplied ground truth data as discussed with regard to FIG. 3B, each time the user provides or updates the prompts and/or requirements. In FIG. 3C, the accident number from document named “ARV3_10.pdf” is correctly labeled by the LLM, while a series No. from the document named “AR_V8.pdf” is highlighted as being predicted, being evaluated by the performance metrics as “FALSE+” or False Positive, which indicates an outcome where the model incorrectly predicts a positive class.

In yet another embodiment, in FIG. 3D, the user may choose to further specify and fine tune the instructions provided to the LLM, for example adding “No/or other special characters” to the instructions (342), and refresh the examples (332). The user may keep trying and fine tuning instructions provided to the LLM till the user is satisfied with the reviewing results, as being reflected by the performance metrics.

In this case, the user is able to optimize the prompts by relying on a set of performance metrics. A well-crafted prompt can help the model generate more accurate and relevant outputs, while a poorly crafted prompt can lead to incoherent or irrelevant outputs. The F1 score is an indication of how successful the LLM will be in annotating new documents based on the user supplied and improved prompts.

FIG. 3E shows one or more fields defined by the user and provided to the LLM, along with the F1 score associated with each field. When a user is satisfied with the results by the LLM, he or she may choose to apply the model to a larger set of data being provided (340), which is normally a set of data unseen by the LLM, which for example may include one or more documents to be reviewed by the LLM for the defined fields. The process to upload the documents and the actual documents are omitted herein.

FIG. 3F shows the status of the examples after the reviewing process is finished, for example, total 55 examples are being reviewed in this case. It is noted that FIG. 3F only shows 7 of the 55 examples, including examples being labeled both by the LLM which is designated as “Auto-Labeled” (350), and by the user.

In FIG. 3G, the user may choose to review the results labeled by the LLM from the list shown in FIG. 3F, one of the documents named “Arv3-2.pdf” from FIG. 3F is shown in FIG. 3G as an example, the user may make labeling corrections if it is necessary (360) against the document (362), the result(s) can then be submitted as fine-tuned ground truth annotation for future training or reviewing purpose. The initial human-supplied ground truth data and the labels generated through optimized prompting of a large language model (LLM) like GPT4 can be submitted and used to train a discriminative model, for example, a smaller, for-purpose, fine-tuned transformer (e.g. RoBERTa) model.

It is noted that during the bootstrapping and refining the annotation, iterations may be required successively, which may include incorporating feedback, reviewer expertise, and continuous fine-tuning of prompts.

The fusion of human-supplied ground truth and GPT in the data annotation process presents an exciting avenue for improved accuracy and efficiency. By harnessing the power of language models, the bootstrapping and refinement of human data annotation become more scalable and reliable.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this presentation with respect to the current state of the art, but also contemplates advancements and that adaptations in the future may take into consideration of those advancements, namely in accordance with the then current state of the art. Reference to a feature element in the singular is not intended to mean “one and only one” unless explicitly so stated. Moreover, no element, component, nor method or process step in this presentation is intended to be dedicated to the public regardless of whether the element, component, or step is explicitly recited in this presentation. No element disclosed herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . ”

1. A method of data analysis for training a discriminative machine learning model, comprising:
providing a set of data;
instructing a large language model (LLM) to review the set of data for a predefined task with or without one or more prompts by a user;
producing performance metrics comparing results provided by the LLM to a set of initial human-supplied ground truth data generated by the user;
updating or providing one or more prompts for the LLM by the user based on the performance metrics in a case that the performance metrics does not reach a threshold;
generating one or more renewed results by the LLM according to the updated or provided one or more prompts and producing performance metrics of the one or more renewed results such that the performance metrics reach a threshold; and
reviewing and submitting the set of initial human-supplied ground truth data and the results of the LLM for training the discriminative machine learning model.

2. The method of claim 1, further comprising:
analyzing a set of predetermined amount of data by the user to generate the set of initial human-supplied ground truth data.

3. The method of claim 1, wherein the set of data comprises one or more documents comprising raw text.

4. The method of claim 1, further comprising: applying the provided or updated one or more prompts to a set of data that the LLM has not seen.

5. The method of claim 1, wherein the predefined task comprises labeling, instant scaling, collection, classification or annotation.

6. The method of claim 1, wherein the discriminative machine learning model comprises a small, for-purpose, fine-tuned transformer.

7. The method of claim 6, wherein the discriminative machine learning model comprises a Robustly Optimized BERT Pretraining Approach (ROBERTa) model, a Decoding-enhanced BERT with disentangled attention (DeBERTa) model, or Longformer.

8. The method of claim 1, wherein the LLM comprises Generative Pre-trained Transformer (GPT).

9. The method of claim 1, wherein the performance metrics comprise F1-score, Precision, Recall, False+, False− or True+.

10. The method of claim 1, further comprises enabling human quality assurance of the results generated by the LLM before submitting, and the human quality assurance comprises checking or correcting the results by the user.

11. The method of claim 1, further comprising providing one or more requirements to the LLM by the user for the data to meet or adhere to.

12. The method of claim 11, wherein the one or more requirements are provided to the LLM prior to or subsequent to the user providing or updating the one or more prompts to the LLM.

13. The method of claim 11, wherein the one or more requirements comprising predefined criteria or format for the data to meet or adhere to.

14. The method of claim 12, wherein the one or more requirements are provided to the LLM subsequent to the user providing or updating the one or more prompts to the LLM.

15. The method of claim 14, further comprising generating one or more results by the LLM according to the provided one or more requirements, and producing performance metrics of the one or more results.

16. A Graphic User Interface (GUI) system of data analysis for training a discriminative machine learning model, comprising:
an input arranged for providing a set of data to be analyzed by a Large Language Model (LLM);
an interface for defining one or more fields by a user for the LLM to review the set of data for information;
a display arranged for displaying one or more results output by the LLM in accordance with the defined one or more fields;
a processor configured to produce performance metrics comparing the one or more results provided by the LLM to a set of initial human-supplied ground truth data, wherein the display is configured to display the performance metrics;
an input for providing or updating one or more prompts for the LLM based on the performance metrics till the performance metrics reach a threshold;
wherein the display is further configured to display results by the LLM according to the provided or updated one or more prompts, and display the performance metrics of the one or more renewed results; and
a second interface for reviewing and submitting the set of initial human-supplied ground truth data and the results of the LLM for training the discriminative machine learning model.

17. The Graphic User Interface (GUI) system of claim 16, further comprising: an interface allowing the user to analyze a subset of the data to generate the set of initial human-supplied ground truth data.

18. The Graphic User Interface (GUI) system of claim 16, wherein the set of data comprises one or more documents comprising raw text.

19. The Graphic User Interface (GUI) system of claim 15, further comprising: an interface for applying the provided or updated one or more prompts to a set of data that the LLM has not seen.

20. The Graphic User Interface (GUI) system of claim 16, wherein the predefined task comprises labeling, instant scaling, collection, classification and/or annotation.

21. The Graphic User Interface (GUI) system of claim 16, wherein the discriminative machine learning model comprises a small, for-purpose, fine-tuned transformer.

22. The Graphic User Interface (GUI) system of claim 21, wherein the discriminative machine learning model comprises a Robustly Optimized BERT Pretraining Approach (ROBERTa) model, a Decoding-enhanced BERT with disentangled attention (DeBERTa) model, or Longformer.

23. The Graphic User Interface (GUI) system of claim 16, wherein the LLM comprises Generative Pre-trained Transformer (GPT).

24. The Graphic User Interface (GUI) system of claim 16, wherein the performance metrics comprise F1-score, Precision, Recall, False+, False− or True+.

25. The Graphic User Interface (GUI) system of claim 16, wherein the display is further configured to enable human quality assurance of the results generated by the LLM before submitting, and the human quality assurance comprises checking or correcting the results by the user.

26. The Graphic User Interface (GUI) system of claim 16, further comprising an input for providing one or more requirements to the LLM by the user for the data to meet or adhere to.

27. The Graphic User Interface (GUI) system of claim 26, wherein the one or more requirements are provided to the LLM prior to or subsequent to the user providing or updating the one or more prompts to the LLM.

28. The Graphic User Interface (GUI) system of claim 26, wherein the one or more requirements comprising predefined criteria or format for the data to meet or adhere to.

29. The Graphic User Interface (GUI) system of claim 27, wherein the one or more requirements are provided to the LLM subsequent to the user providing or updating the one or more prompts to the LLM.

30. The Graphic User Interface (GUI) system of claim 29, wherein the display is further configured to display results generated by the LLM according to the provided one or more requirements, and the performance metrics of the one or more renewed results.

31. The Graphic User Interface (GUI) system of claim 26, wherein the input for providing the one or more requirements is configured to be the same as or different from the input for providing or updating the one or more prompts.
